(19) United States
(12) Patent Application Publication
(10) Pub. No.: US 2021/0297245 A1
(43) Pub. Date: Sep. 23, 2021

(54) Method And Arrangement For Secure Electronic Data Communication

(71) Applicant: SIEMENS MOBILITY GMBH, Müchen (DE)

(72) Inventors: UWE ECKELMANN-WENDT, WOLFENBUETTEL (DE); STEFAN GERKEN, BRAUNSCHWEIG (DE); MARKUS SEEMANN, BRAUNSCHWEIG (DE)

(21) Appl. No.: 16/326,439

(22) PCT Filed: Jul. 18, 2017
(86) PCT No.: PCT/EP2017/068072

§ 371 Date: Feb. 19, 2019

(30) Foreign Application Priority Data
Aug. 18, 2016 (DE) 102016215520.2

(51) Int. Cl. H04L 9/08; H04L 9/32

(52) U.S. Cl. CPC H04L 9/0825; H04L 9/3247; H04L 9/3242; H04L 9/0894

(57) ABSTRACT

An arrangement provides secure electronic data communication according to the publish/subscribe model between information-processing units of the arrangement. The data communication is secured on the basis of an asymmetric encryption method. Each of the information-processing units is associated with a hardware-type secured zone in which the respective information-processing unit is arranged. A zone key pair containing a public zone key and a secret zone key is associated with each of the zones. Each of the zones contains an encryption unit embodied as a hardware module, which is configured to store the secret zone key in a secure manner and to perform cryptographic operations by use of the secret zone key.

The invention relates to a method and an arrangement for secure electronic data communication according to the publish-subscribe pattern between information-processing units of the arrangement, on the basis of an asymmetric encryption method.

According to the publish-subscribe pattern, an information-processing unit can publish a message without addressing a particular recipient. Potential recipients need not be known to the publishing unit. Nor is it necessary for the unit that publishes a message to receive a response message to the published message. On the other hand, each information-processing unit can subscribe to particular messages in accordance with predetermined criteria, that is to say can sign up to be a recipient of a message.

In the context of the present invention, block or packet-based data communication—based for example on messages, datagrams, telegrams or similar—is considered, in contrast to stream-based data communication.

In the context of the present invention, the term “information-processing units” is understood to mean substantially technical units, in particular control programs of technical units. However, programs and/or processes that can be executed on a processor, for example a server, or a virtual machine on the processor, may be information-processing units in the sense used in the present invention.

Data communication includes any type of messages that are exchanged between the information-processing units. In rail engineering, which represents a preferred area of application of the present invention, messages of this kind may for example serve to control rail traffic directly or indirectly. This relates for example to the operation of railroad switches and signaling equipment, to testing whether stretches of track are free or occupied, and so on.

In order to protect these messages from unauthorized access, in particular to secure the authenticity of the message, the data communication may be secured cryptographically. The use of asymmetric encryption, in which a pair of keys, comprising a public key and a private key, is associated with each information-processing unit, in principle provides sufficient protection here. This therefore provides a reliable way to check the authenticity of a message. A unit publishing the message can generate an authenticity certificate by signing a message using the private key associated with the unit. A unit that subscribes to this message can then check this signature using the public key of the published unit.

With this solution it is disadvantageous that, because of the very large number of information-processing units which are for example involved in controlling rail traffic, the management and provision of all the public keys and in particular securing of all the private keys demands considerable complexity.

It is accordingly the object of the present invention to propose an arrangement and a method that reduce the complexity of providing secure electronic packet or block-based data communication in the context of a publish-subscribe pattern between information-processing units, with a constant level of security.

This object is achieved by an arrangement and a method having the features of the independent claims. Advantageous embodiments and developments are given in the dependent claims.

According to the invention, an arrangement for secure electronic data communication between information-processing units of the arrangement is provided. It is based on the publish-subscribe pattern, and data communication is secured on the basis of an asymmetric encryption method. Each of the information-processing units is associated with a hardware-secured zone in which the respective information-processing unit is arranged. At least one zone key pair, comprising in each case a public zone key and a private zone key, is associated with each of the zones. Each of the zones includes at least one encryption unit that takes the form of a hardware module and is constructed to store the private zone key or keys securely and to perform cryptographic operations using the private zone key or keys and the public zone key or keys.

Preferably, the encryption unit is the only unit of the corresponding zone that has access to the private zone key or keys.

The method according to the invention for secure electronic data communication according to the publish-subscribe pattern between information-processing units of an arrangement on the basis of an asymmetric encryption method includes, in principle, the following step:

Associating each of the information-processing units with a hardware-secured zone in which the respective information-processing unit is arranged.

For each of the zones, furthermore the following steps are performed:

Generating at least one zone key pair comprising a public zone key and a private zone key;

Associating the zone key pair with the zone, and securely storing the private zone key in an encryption unit of the zone that takes the form of a hardware module, wherein the encryption unit is constructed to perform cryptographic operations using the private zone key and the public zone key.

According to a preferred embodiment, the zone key pair is generated in the zone itself, preferably by the encryption unit associated with the zone. In this case, the private zone key never leaves the encryption unit, and so has optimum security.

A hardware module according to the invention is constructed, as the encryption unit, to store securely at least one private key of a key pair of an asymmetric encryption system and to perform cryptographic operations using the private key.

Because the encryption unit takes the form of a hardware module, not only is the private zone key stored therein sufficiently secure, but cryptographic operations that are performed by the encryption unit, such as encryption, decryption, digital signature or verification of a digital signature, can be performed considerably more quickly than with a functionally comparable software module. In particular in conjunction with applications that have to fulfill requests in real time, this gives major advantages.

A processing unit according to the invention, in particular a server, includes at least one hardware module according to the invention and at least one information-processing unit. The processing unit is constructed to support a method of the type described above and below in the role of a hardware-secured zone.

The invention is based on the realization that, in the present context, there is no need to generate a separate key pair for each individual information-processing unit, but that it is sufficient to group the information-processing units in a suitable manner—that is to say to associate them with defined hardware-secured zones, and to associate a separate key pair, a so-called zone key pair, only with each of these zones.

In the context of the present invention, the term “hardware-secured” should be understood to mean that the corresponding zone is secured against unauthorized access from the outside not only by way of access rights or other software means but at least in addition physically, by specific hardware means. Preferably, a zone is provided by a processor, in particular a server. It is possible for a processor to include a plurality of different zones in the sense used in the present invention, and consequently to include a plurality of hardware modules serving as encryption units of these zones. In the event—which is not in fact preferred but is possible—that a zone includes a plurality of processors, there are between the processors intra-zone connections that are separate and physically isolated from connections to the outside. In the context of the present invention, the term “zone” is used in conformance with a definition of this term as found for example in standard IEC62443-3-3 under point 3.1.47.

Here, there may be associated with a zone in particular the information-processing units that are already arranged in that zone. If the zone is provided for example by a server, then programs or processes that can be executed on the server may be associated with this zone as information-processing units.

As explained in more detail below, according to the invention data communication can in principle be performed in known manner, on the basis of the asymmetric encryption system. Here, no importance is attached to whether the information-processing unit that publishes a message is associated with the same zone as an information-processing unit subscribing to the message. In addition to the item of information of which zone a message originates from—information that is generated by the private zone key associated with the zone—a publishing information-processing unit may be constructed to integrate an item of sender information that is typically not cryptographically secured (for example in the form of a so-called publisher UUID) into the message, for example in a message header. A subscribing information-processing unit is then constructed to evaluate the item of sender information, for the purpose of establishing the identity of the publishing unit.

According to one embodiment, a first information-processing unit of a first zone is constructed to publish a message. Here, the message is cryptographically secured using the private zone key associated with the first zone. A second information-processing unit is constructed to authenticate the message, using the public zone key associated with the first zone, as a message that has been sent by an information-processing unit of the first zone.

The first information-processing unit may be constructed to integrate an item of sender information into the message. The second information-processing unit may be constructed to evaluate the sender information for the purpose of establishing the identity of the sender of the message.

According to a preferred embodiment, the step of publishing a message may include the following sub-steps:

The message is generated by the first information-processing unit. Then a hash value relating to the message is determined, preferably by the first information-processing unit itself. As an alternative, the hash value may also be formed by the encryption unit of the corresponding zone.

Then the hash value is signed digitally by the encryption unit of the zone with which the first information-processing unit is associated, using the private zone key that is associated with the zone and stored in the encryption unit. This may be performed for example in that the hash value is encrypted using the private zone key.

The signed hash value is then attached to the message by the first information-processing unit, and the message, together with the attached digitally signed hash value, is published by the first information-processing unit.

The step of authenticating the message by the second information-processing unit then preferably includes the following sub-steps:

A reference hash value relating to the message is determined by the second information-processing unit or by the encryption unit of the zone with which the second information-processing unit is associated.

Then, the encryption unit of the zone with which the second information-processing unit is associated verifies the digitally signed hash value that is attached to the message, using the public zone key that is associated with the first zone. This may be performed for example in that an encrypted hash value is decrypted by the public zone key associated with the first zone.

The verified hash value is then compared with the reference hash value. Only if they agree is the message deemed to be authentic—that is to say to be a message that has been published by an information-processing unit of the first zone.

Preferably, the encryption unit of each zone is constructed to generate for the zone a new zone key pair, comprising a new public zone key and a new private zone key. In order to maintain security and authenticity of data communication, the keys associated with a zone are preferably replaced at regular or irregular intervals.

The new public zone key can then be published by the encryption unit through a message. This message is still secured using the previous private zone key of that zone.

Each information-processing unit that subscribes to this message is thereby informed of the replacement of the key pair in the appropriate zone and, once the new public zone key of this zone has been received, can also authenticate such messages, which are then cryptographically secured using the newly generated private zone key of this information-processing unit.

The encryption unit is accordingly preferably also constructed to store different private zone keys securely, at least temporarily.

Different solutions can be found to publishing the initial public zone key. It must in principle be ensured that no public zone keys are entered into the system without authorization. One way to do this consists in providing the keys with conventionally known digital certificates from a certification agency that is deemed to be trustworthy by the system—that is to say by all the zones. As an alternative, all the zones may be equipped with a private master key by which the initial public zone keys can be published securely. Finally, it is possible for public zone keys to be passed on between neighboring zones by way of secure communication channels between these zones, for example on the basis of a Diffie-Hellman method.

According to a preferred embodiment, it is provided for the encryption unit to store different private zone keys, including private zone keys of different lengths, at the same time. Respective public zone keys of corresponding length are associated with these different private zone keys in a conventionally known manner.

In other words, the method can include the following steps: generating a further zone key pair comprising a further public zone key and a further private zone key, wherein the key length of the keys of the further zone key pair may differ from the key length of the keys of the zone key pair. The further zone key pair is associated with the appropriate zone, and the further private zone key is stored securely in the encryption unit of the zone.

There may be associated with a zone for example four zone key pairs of different lengths, for example with key lengths of 40 bits, 80 bits, 200 bits and 400 bits. The shorter the keys, the more frequently they are replaced. As an alternative to the variant described above, in accordance with which a message is cryptographically secured for the purpose of publishing a newly generated public zone key using the old private zone key (of the same length), according to a preferred variant, the procedure may also be as follows: a message for publication of a new public zone key of a first length is cryptographically secured using a private zone key of a second length, wherein the second key length is greater than the first key length. That is to say that a 40-bit key is secured for example using an 80-bit key, an 80-bit key is secured using a 200-bit key, and so on.

Because, in the context of data communication, every published message in the arrangement should always be secured in the manner described above—and in the context of rail signaling technology, for example, there may be very many messages—it is important that the generation and checking of the corresponding signatures can be performed quickly. The time required for generating or checking a signature—that is to say in particular for encrypting and decrypting a hash value relating to a message—in turn depends directly on the length of the keys used. For this reason, according to a preferred embodiment relatively short private zone keys are used to secure messages that are to be published very frequently. These relatively short private zone keys should then be replaced correspondingly more frequently by new private zone keys (of the same length), in the manner described above. Relatively long private zone keys may be used to secure messages that are published less frequently, such as messages by which newly generated public zone keys are distributed. In principle, long keys provide a higher level of security than short keys.

In the event that different private zone keys are associated, in the long term or temporarily, to a zone, it may be advantageous to cryptographically secure a published message using different private zone keys in the manner described above.

In other words, the method may include the following steps:

Publishing a message by a first information-processing unit of a first zone, wherein the message is cryptographically secured using a first private zone key that is associated with the first zone, and wherein the message is additionally cryptographically secured using a second private zone key that is associated with the first zone and is different from the first private zone key. Here, securing using the two private keys is performed separately, as described above—that is to say that two digitally signed hash values are attached to the message, the one signed using the first private zone key and the second using the second private zone key. It will be appreciated that it is also possible to use more than two private zone keys, for example three or four, to cryptographically secure a message.

In order to authenticate a message of this kind that has been secured multiple times, a subscribing unit needs to check only one of the two signatures.

A procedure of this kind is useful for example if a recently newly generated public zone key has not yet been passed on sufficiently within the arrangement. In this way, for a transitional period every message can be secured using the “old” private zone key and the “new” (that is to say recently newly generated) private zone key. Once a predetermined time period has elapsed, it is then possible to dispense with securing using the “old” private zone key.

In principle, by securing a message using different private zone keys, the security of data transmission can be enhanced and where appropriate account can be taken of locally or temporally uneven distribution of public zone keys.

The above-described properties, features and advantages of this invention, and the manner in which these are achieved, will be clearer and more easily understood in conjunction with the description below of the exemplary embodiments, which are explained in more detail with reference to the drawings, in which:

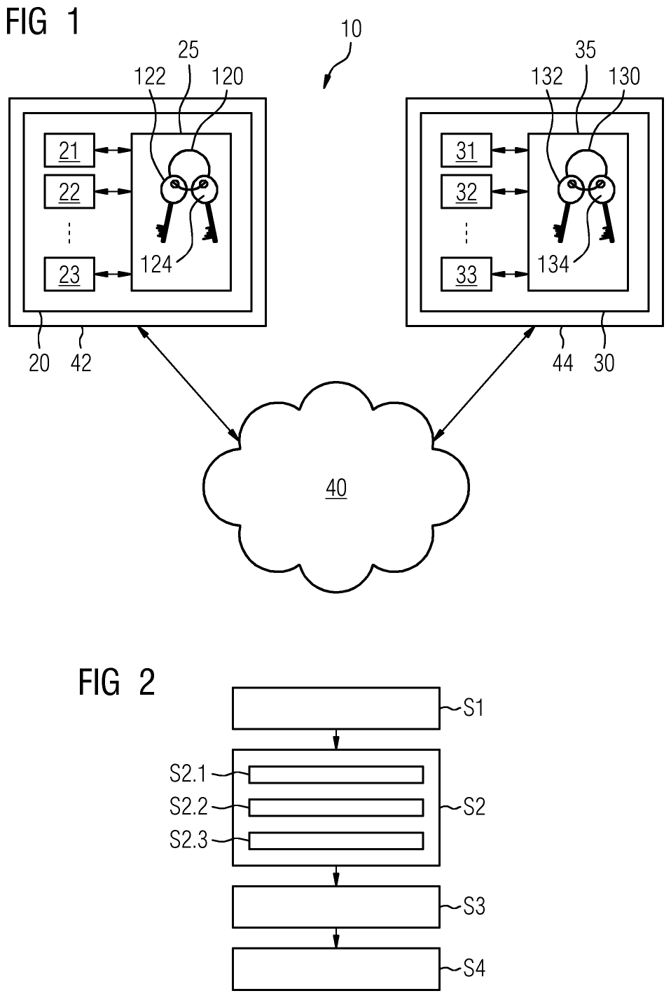

FIG. 1 shows schematically an embodiment of an arrangement according to the invention, and

FIG. 2 shows steps of a method according to the invention.

FIG. 1 shows an arrangement 10 for secure electronic data communication such as could be performed for example in rail signaling technology. The arrangement 10 includes a plurality of information-processing units 21, 22, 23, 31, 32, 33, between which data communication is performed over a data communication network 40. Here, data communication is performed according to the so-called publish-subscribe pattern. In this, a message is published by an information-processing unit 21 without one or more recipients of the message being addressed specifically, in a manner similar to a broadcast or multicast method. Each information-processing unit 22, 23, 31, 32, 33 can subscribe to particular messages in accordance with predetermined criteria, that is to say can sign up to be a recipient of a message. In other words, a message may also be subscribed to by a plurality of information-processing units 22, 23, 31, 32, 33.

Here, the information-processing units 21, 22, 23, 31, 32, 33 are associated with respectively different hardware-secured zones 20, 30—that is to say that each of the information-processing units is associated with one of the zones 20, 30. The zones 20, 30 take a form in terms of hardware and where appropriate additionally in terms of software such that unauthorized access to the zone 20, 30 from outside is not possible. The number of zones is variable, and may be greater than two. The example in FIG. 1 is only restricted to the two zones 20, 30 for the sake of simplicity.

Typically, an information-processing unit 21, 31 is associated with the zone 20, 30 in which it is arranged. In the embodiment shown, the first group of information-processing units 21, 22, 23 corresponds to a plurality of programs or processes that may be executed on a sever 42 that provides or includes the hardware-secured zone 20.

This server 42 is connected to the data communication network 40 and may be arranged for example in a control center or similar. From this server 42 there are published messages, which may be subscribed to by information-processing units of the same or another zone 30. Such other information-processing units 31, 32, 33 may for example be control programs of technical devices, for example controllers of railroad switches or signaling equipment. The information-processing units 31, 32, 33 are associated with a second zone 30 that is different from the first zone 20 and is provided on a further server 44, which is likewise connected to the data communication network 40.

Associated with each of the zones 20, 30 is a zone key pair 120, 130, comprising in each case a public zone key 122, 132 and a private zone key 124, 134, as a result of which authenticatable data communication between information-processing units 21, 22, 23, 31, 32, 33 may be performed regardless of the zone with which it is associated, as will be explained in more detail below with reference to FIG. 2.

Each of the zones 20, 30 includes in each case an encryption unit 25, 35 that takes the form of a hardware module. This is constructed to store securely at least the private zone key 124, 134 associated with the zone 20, 30 respectively. Preferably, the encryption unit 25 of a zone 20 additionally stores the respectively associated public zone key 122 and where appropriate public zone keys 132 of other zones 30. The encryption unit 25, 35 is constructed to perform cryptographic operations using the private zone key 124, 134.

The information-processing units 21, 22, 23 of a zone 20 are each constructed to communicate with the encryption unit 25 of the zone 20, for example in order to transfer to the encryption unit 25 data that is to be signed digitally, and to receive signed data.

FIG. 2 shows, by way of example, steps of a method for secure electronic data communication according to the publish-subscribe pattern between information-processing units 21, 31 of the arrangement 10 in FIG. 1, on the basis of an asymmetric encryption method.

In step S1, each of the information-processing units 21, 22, 23, 31, 32, 33 is associated with the hardware-secured zone 20, 30 in which the respective unit is arranged. As already described above, in the arrangement 10 that is illustrated by way of example in FIG. 1, only two zones 20, 30 are provided. It will be appreciated that the number of zones is not restricted to two. The number of information-processing units per zone is variable.

In step S2, cryptographic keys are associated with the individual zones 20, 30 and are then used to enable subsequent data communication between information-processing units 21, 31, to be carried out securely and in particular authenticatably.

In step S2.1, first of all a zone key pair 120, 130 is generated for each of the zones 20, 30. A zone key pair of this kind comprises in each case a public zone key 122, 132 and a private zone key 124, 134.

In step S2.2, there is associated with each zone 20, 30 the zone key pair 120, 130 that is generated for this zone.

In step S2.3, the private zone key 124, 134 that is associated with a zone 20, 30 is stored securely in the encryption unit 25, 35 of the respective zone 20, 30. The information-processing units 21, 31 of a zone 20, 30 do not typically have any access to the private zone key 124, 134.

In this context, the public zone keys 122, 132 may be made available to all the information-processing units or all the zones 20, 30 of the arrangement 10, in a conventionally known manner.

In step S3, an information-processing unit 21 of the first group 20 then publishes a message, which may be subscribed to by any other information-processing units 22, 31, as desired. The message is digitally signed using the private key 124 of the first zone 20.

To be more precise, first of all a hash value for the message is formed. This hash value is then signed by the encryption unit 25 using the private zone key, for example by encrypting the hash value using this private zone key 124. Then, the encrypted hash value is attached to the message, and the message is published together with the attached encrypted hash value.

If for example the information-processing unit 31 has subscribed to this message, then once it receives the message it can check the origin of the message in step S4, by verifying the digital signature using the public zone key 122 of the first zone 20.

To be more precise, the unit 31 can form a reference hash value relating to the message. The encrypted hash value that is attached to the message can be decrypted by the encryption unit 35 of the zone 30, with which the unit 31 is associated, using the public zone key 122 associated with the zone 20. In the event that the decrypted hash value agrees with the reference hash value, it is assumed that the message does in fact originate from the zone 20.

This makes it possible to ensure that no messages with a false identity infiltrate the arrangement 10 (in a so-called “masquerade” under EN 50159). The information-processing units 31, 32, 33 of the second zone 30 on the server 44 may for example be constructed such that they only subscribe to and process messages that originate from the server 42—that is to say have been signed using the private zone key associated with the first zone 20. The exact sender identity—that is to say which of the information-processing units 21, 22, 23 has published the message—can additionally be encoded for example in a header of the message.

Although the invention has been illustrated and described in detail by preferred exemplary embodiments, the invention is not restricted by the disclosed examples, and those skilled in the art will be able to derive other variations therefrom without departing from the scope of protection of the invention.

1-15. (canceled)

16. A configuration for secure electronic data communication according to a publish-subscribe pattern, the configuration comprising:
hardware-secured zones;
information-processing units communicating with each other on a basis of an asymmetric encryption method, each of said information-processing units is associated with one of said hardware-secured zones in which a respective one of said information-processing units is disposed;
a zone key pair including a public zone key and a private zone key is associated with each of said hardware-secured zones; and
each of said hardware-secured zones having an encryption unit being a hardware module and is constructed to store said private zone key securely and to perform cryptographic operations using said private zone key.

17. The configuration according to claim 16, wherein at least one of said hardware-secured zones is a server or a virtual machine on a server.

18. The configuration according to claim 16, wherein said information-processing units include a first information-processing unit of a first zone of said hardware-secured zones is constructed to publish a message, wherein the message is cryptographically secured using the private zone key that is associated with said first zone, and in that a second information-processing unit of said information-processing units is constructed to authenticate the message, using the public zone key associated with said first zone, as a message that has been published by said first information-processing unit of said first zone.

19. The configuration according to claim 18, wherein said first information-processing unit is constructed to integrate an item of sender information into the message, and wherein said second information-processing unit is constructed to evaluate the sender information for establishing an identity of a sender of the message.

20. The configuration according to claim 16, wherein said information-processing units are in a form of technical units, in a form of control programs of said technical units, and/or in a form of processes that can be executed on a server or a virtual machine on a server.

21. The configuration according to claim 16, wherein each said encryption unit of said hardware-secured zones is constructed to:
generate a new zone key pair which contains a new public zone key and a new private zone key; and
publish the new public zone key through a message that is secured using a previous private zone key.

22. A method for secure electronic data communication according to a publish-subscribe pattern between information-processing units of a configuration, on a basis of an asymmetric encryption method, which comprises the steps of:
associating each of the information-processing units with a hardware-secured zone in which a respective one of the information-processing units is disposed;
generating, for each of the hardware-secured zones, a zone key pair containing a public zone key and a private zone key;
associating the zone key pair with the hardware-secured zone; and
securely storing, for each of the hardware-secured zones, the private zone key in an encryption unit of the hardware-secured zone that takes a form of a hardware module, wherein the encryption unit is constructed to perform cryptographic operations using the private zone key.

23. The method according to claim 22, which further comprises the steps of:
publishing a message by a first information-processing unit of the information-processing units of a first zone of the hardware-secured zones, wherein the message is cryptographically secured using the private zone key associated with the first zone; and
authenticating the message by a second information-processing unit of the information-processing units, using the public zone key associated with the first zone, as the message that has been published by the first information-processing unit of the first zone.

24. The method according to claim 23, wherein the publishing step includes the following sub-steps:
generating the message by the first information-processing unit;
determining a hash value relating to the message;
digitally signing the hash value using the private zone key, by the encryption unit of the first zone;
attaching a signed hash value to the message by the first information-processing unit; and
publishing the message, together with an attached digitally signed hash value, by the first information-processing unit.

25. The method according to claim 23, wherein the step of authenticating the message by the second information-processing unit includes the following sub-steps:
determining a reference hash value relating to the message;
verifying the hash value attached to the message on a basis of the public zone key that is associated with the first zone, by the encryption unit of the hardware-secured zone with which the second information-processing unit is associated; and
comparing a verified hash value with the reference hash value.

26. The method according to claim 22, which further comprises performing the following steps, performed by the encryption unit of one of the hardware-secured zones:
generating for the hardware-secured zone a new zone key pair, containing a new public zone key and a new private zone key; and
publishing the new public zone key through a message, wherein the message is cryptographically secured using a previous private zone key of the zone.

27. The method according to claim 22, which further comprises performing the following steps for at least one of the hardware-secured zones:
generating a further zone key pair containing a further public zone key and a further private zone key, wherein a key length of keys of the further zone key pair may differ from a key length of keys of the zone key pair;
associating the further zone key pair with the hardware-secured zone; and
securely storing the further private zone key in the encryption unit of the hardware-secured zone.

28. The method according to claim 26, which further comprises:
publishing a message by a first information-processing unit of the information-processing units of a first zone of the hardware-secured zones, wherein the message is cryptographically secured using a first private zone key that is associated with the first zone, and wherein the message is additionally cryptographically secured using a second private zone key that is associated with the first zone and is different from the first private zone key.

29. The method according to claim 24, wherein the digitally signing step is an encryption step of the hash value.

30. The method according to claim 25, wherein the verifying step is a decryption step.

31. A hardware module, comprising:
an encryption unit to store securely at least one private key of a key pair of an asymmetric encryption system and to perform cryptographic operations using the private key.

32. A processing unit, comprising:
at least one hardware module having an encryption unit for storing securely at least one private key of a key pair of an asymmetric encryption system;
at least one information-processing unit;
a processor being a hardware-secured zone for secure electronic data communication according to a publish-subscribe pattern between information-processing units of a configuration, on a basis of an asymmetric encryption method, said processor programmed to:
associate said information-processing unit with said hardware-secured zone in which said information-processing unit is disposed;
generate, for said hardware-secured zone, a zone key pair containing the public zone key and the private zone key;
associate, for said hardware-secured zone, the zone key pair with said hardware-secured zone; and
securely store, for said hardware-secured zone, the private zone key in said encryption unit, said encryption unit is constructed to perform cryptographic operations using the private zone key.
